(19) United States
(12) Patent Application Publication
(10) Pub. No.: US 2017/0293281 A1
(43) Pub. Date: Oct. 12, 2017

(54) SYSTEMS AND METHODS FOR CONTROLLING POWER MOTION FURNITURE

(71) Applicant: Raffel Systems, LLC, Germantown, WI (US)

(72) Inventors: Paul Li, Milwaukee, WI (US); Paul F. Stangl, West Bend, WI (US); Richard M. Weeden, Cedarburg, WI (US); Kenneth G. Seidl, Port Washington, WI (US); Torrin T. Santy, West Bend, WI (US); Mitchell P. Rath, Menomonee Falls, WI (US)

(21) Appl. No.: 15/155,363

(22) Filed: May 16, 2016

Related U.S. Application Data
(60) Provisional application No. 62/318,993, filed on Apr. 6, 2016.

(51) Int. Cl. G05B 19/16; G05B 19/409; A47C 17/04; A47C 1/034; A47C 1/03; A47C 1/12; G05B 19/042; A47C 1/024

(52) U.S. Cl. CPC G05B 19/16; G05B 19/0426; G05B 19/409; A47C 1/0242; A47C 1/0342; A47C 1/03; A47C 1/034; A47C 1/12; A47C 17/04; G05B 2219/41176

(57) ABSTRACT

The present invention relates to power motion furniture, power motion furniture systems and methods of using the same. In particular, the present invention provides systems and methods for controlling power motion furniture positioning comprising a physical alert (e.g., to indicate furniture component positioning).

### FIELD OF THE INVENTION

The present invention relates to power motion furniture, power motion furniture systems and methods of using the same. In particular, the present invention provides systems and methods for controlling power motion furniture positioning comprising a physical alert (e.g., to indicate positioning).

### BACKGROUND OF THE INVENTION

Many types of furniture exist in the marketplace. Some furniture contains features that allow for manual adjustment of the furniture (e.g., a LA-Z-BOY manual recliner, Monroe, Michigan). Other furniture contains powered (e.g., electronically, pneumatically, hydraulically, etc.) actuators that move furniture component parts (e.g., from a sitting to a fully reclined position) in an effortless manner (e.g., via the push of a button). Some powered furniture possess controllers that allow a user to store positions into memory. Memory controllers have utilized visible, LED displays as well as audible indicators in order to provide a user information regarding memory positions.

### SUMMARY OF THE INVENTION

The present invention relates to power motion furniture, power motion furniture systems and methods of using the same. In particular, the present invention provides systems and methods for controlling power motion furniture positioning comprising a physical alert (e.g., to indicate positioning).

Accordingly, in some embodiments, the present invention provides a system for controlling power motion furniture positioning comprising a physical alert means (e.g., for indicating a specific positioning of one or more components of the furniture (e.g., indicating a specific positioning of one or more components of the furniture has been set and/or saved (e.g., into a memory storage means)). In some embodiments, the system further comprises a controller comprising a switch and a memory storage means. The present invention is not limited to any particular switch or memory storage means. In some embodiments, the system further comprises an actuator. The present invention is not limited to any specific actuator. Indeed, furniture comprising a system for controlling power motion of the positioning of furniture components may contain an actuator known in the art including, but not limited to, a mechanical actuator, a pneumatic actuator, a hydraulic actuator, an electronic actuator, or other type of actuator used in power motion furniture (e.g., to control all or a portion of an arm chair, love seat, sofa, sectional, theater seating, and/or bed frame). Similarly, furniture comprising a system for controlling power motion of the positioning of furniture components of the invention may contain any known memory storage means including, but not limited to, an internal hard drive, an external hard drive, and a jump drive. In some embodiments, the memory storage means is a memory chip. The present invention is not limited by the type of memory chips utilized. Indeed, a variety of memory chips may be utilized including, but not limited to, dynamic random access memory (DRAM) chips, FLASH memory chips, static random access memory (SRAM) chips, specialty memory chips, ferroelectric random access memory (FRAM) chips, electrically erasable programmable read-only memory (EEPROM) chips, first-in, first-out (FIFO) memory chips, erasable programmable read-only memory (EPROM) chips, non-volatile random access memory (NVRAM) chips, memory cards, a collection of chips (e.g., SRAM modules, DRAM modules, etc.), etc. In some embodiments, the memory component stores operational use information (e.g., information related to furniture component positioning). In some embodiments, the system for controlling power motion furniture positioning further comprises a means for setting and/or storing information related to furniture component positioning within the memory storage means. The invention is not limited to any particular means for setting and/or storing the information related to furniture component positioning. Indeed, any means known in the art can be used to set and/or store information related to furniture component positioning within the memory storage means including, but not limited to, those described herein. The invention is not limited by the type of information related to furniture position (e.g., set and/or stored in a memory storage means). In some embodiments, the information related to furniture position comprises a memory position (e.g., of one or more components of the furniture (e.g., the back or backrest, neck rest, seat, leg rest, foot rest, arm, leg, or other movable component)). The memory position may be a position initially stored in a memory storage means of the system (preset memory position) or one that is set by a user (user memory position) (e.g., during use of the furniture). One, two, three, four, five, six, seven, eight, nine, ten or more (e.g., 15, 20, 25, 30, 35, 40 or more) different memory positions may be stored in a memory storage means at any given time (e.g., one or more memory positions of all or a portion of an arm chair, love seat, sofa, sectional, theater seating, and/or bed frame (e.g., recline position, ottoman position, seat tilt, seat height, arm rest height, lumbar support, and/or head rest tilt)). The invention is not limited by the physical alert means used in a system for controlling power motion furniture (e.g., for indicating a specific positioning of the furniture component (e.g., setting and/or storing information related to furniture positioning (e.g., into a memory storage means))). In one embodiment, the physical alert means comprises a movement and/or engagement of all or a portion of the furniture components (e.g., one or more of the head or headrest, backrest, lumbar, seat, leg rest, foot rest, neck or neck rest, arm or armrest, leg or legs, lift, massage, or other movable component) to indicate a specific positioning of the furniture components (e.g., has been set and/or saved (e.g., into a memory storage means), has been selected, and/or has been attained). In one embodiment, the movement is a back and forth movement. In another embodiment, the movement is a side to side movement. In still another embodiment, the movement is a telescoping movement. In yet another embodiment, the movement is an outward and/or inward movement. In another embodiment, the movement is a sideways movement. In another embodiment, the movement is a pulse (e.g., using a solenoid or motor (e.g., massage motor)). In one embodiment, the movement is a cycle and/or cycling movement. In some embodiments, the number of times the movement occurs correlates with a specific memory position of the system (e.g., that has been set, saved, selected, and/or attained). In some embodiments, the physical alert means comprises engagement of a massage mechanism (e.g., located in one or more of the headrest, backrest, lumbar, seat, leg rest, and/or armrests) of the power motion furniture. In some embodiments, the number of times the massage mechanism is engaged and disengaged (e.g., providing a short burst of vibration) correlates with a specific memory position of the system (e.g., that has been set, saved, selected, and/or attained). In some embodiments, the physical alert means comprises a shake, jog, jitter, nudge, poke, tickle, and/or squeeze (e.g., discernable by a user of the piece of furniture). In another embodiment, the physical alert means comprises an electric shock. In yet another embodiment, the physical alert means comprises a puff of air. In a preferred embodiment, the physical alert means is independent from a visible (e.g., LED) alert or signal. In another preferred embodiment, the physical alert means is independent from an audible alert or signal. In a further preferred embodiment, the physical alert means is independent from a visible (e.g., LED) alert or signal and an audible alert or signal. In one embodiment, a system for controlling power motion furniture positioning comprising a physical alert means of the invention is retrofitted into a piece of power motion furniture. In another embodiment, a system for controlling power motion furniture positioning comprising a physical alert means of the invention is a component of a commercially available piece of powered motion furniture. The invention is not limited to any particular type of furniture. Indeed, any furniture comprising power/motion components finds use in the present invention including, but not limited to, chairs, loveseats, sofas, sectionals, theater seating, beds, carts, cots, and/or vehicle (e.g., car, boat, plane, train, bus, truck, motorcycle, and/or other type of vehicle) seating.

In another embodiment, the invention provides a system for controlling the positioning of power motion furniture components comprising a controller comprising a switch and memory storage means; an actuator; a means for setting and saving a specific positioning of the furniture components within the memory storage means; and a physical alert means for indicating that a specific positioning of the furniture components has been set and/or saved in the memory storage means. The invention is not limited to any particular controller, memory storage means, actuator, means for setting and saving specific positioning of the furniture within the memory storage means, and/or a physical alert means. Indeed, any combination of the different types of controllers, memory storage means, actuators, means for setting and saving specific positioning of the furniture within the memory storage means, and/or physical alert means described herein may be used. In one embodiment, the system further comprises a controller comprising software that utilizes a counter (e.g., timer) to determine actuator position. In one embodiment, the controller is universally compatible with any actuator. In another embodiment, the controller (e.g., software) is configured to assign a fully retracted (closed) actuator position a counter value of 0. In a further embodiment, the controller (e.g., software) is configured such that the actuator counter value varies depending on the actuator length and motor speed. For example, in one embodiment, when an actuator is activated, the counter will count up or down depending on the direction of the movement (e.g., a controller can be configured such that when the actuator is closed the counter will count down and when the actuator is open the counter will count up, or vice versa). In one embodiment, the position value is stored in the memory storage means (e.g., on-board flash, external flash device, or on the CPU volatile memory) when the actuator is no longer activated. In some embodiments, when setting a user memory position, the user moves the actuator to a desired position and then saves the actuator position value to a designated user memory number (e.g., a set memory input may be a designated set memory button or a combination set/recall memory button (e.g., press and release to recall memory, press and hold to set memory)). In a further embodiment, upon setting and/or saving a user memory position, the controller software deploys the physical alert means (e.g., moves (e.g., up and down, side to side, etc.) the actuator a number of times equal to the designated user memory number (e.g., user memory position 1 will move one time; user memory position 2 will move two times, etc.)). In some embodiments, upon setting and/or saving a user memory position, the controller software deploys a physical alert means comprising a brief activation (e.g., pulse) of a massage or other mechanism of the furniture for a number of times equal to the designated user memory number (e.g., user memory position 1 will activate/pulse once; user memory position 2 will activate/pulse twice, etc.). In another embodiment, when recalling a user memory position, a controller (e.g., a software component thereof) is configured to verify that the recall is valid. For example, in one embodiment, if the actuator position is equal to or greater than the user memory position number selected, the controller designates the request as invalid and does not change actuator position. In another embodiment, if the actuator position is less than the user memory position number selected, the controller designates the request as valid and the controller proceeds to move the furniture (e.g., via activation of the actuator) into a position equal to the user memory position. In a further embodiment, the controller is configured to prevent the actuator from retracting (e.g., closing) when the actuator position has exceeded the user memory position. Thus, the invention provides means for the controller to allow the actuator to retract/close to the user memory position based upon the furniture's position. The invention is not limited by the means for the controller to allow the actuator to move (retract/close). Indeed, in addition to a counter (e.g., software counter), separate and/or additional means for determining and/or tracking furniture position may be used including, but not limited to, use of an accelerometer, a proximity sensor, an ultrasonic sensor, and/or a spring loaded potentiometer (e.g., in order for the systems and methods of the invention to meet safety parameters (e.g., identification and/or determination of the presence of an obstruction or other unfavorable condition for movement of the furniture)). dr

### DESCRIPTION OF DRAWINGS

FIG. 1 shows an exemplary piece of power motion furniture according to one embodiment of the invention.

FIG. 2 shows a cartoon of an actuator of a system for controlling power motion furniture positioning controlled using two relays in one embodiment of the invention.

FIG. 3 shows control of an actuator using four MOSFETs in an H-Bridge configuration in one embodiment of the invention.

FIG. 4 shows a flow chart depicting the logic flow of a system for controlling power motion furniture according to an embodiment of the invention.

FIG. 5 depicts a memory storage and/or recall process in one embodiment of the invention.

### DETAILED DESCRIPTION OF THE INVENTION

The present invention relates to power motion furniture, power motion furniture systems and methods of using the same. In particular, the present invention provides systems and methods for controlling power motion furniture positioning comprising a physical alert (e.g., as an indication of furniture component positioning).

The following embodiments are provided by way of example and are not intended to limit the invention to these particular configurations. Numerous other applications and configurations will be appreciated by those of ordinary skill in the art.

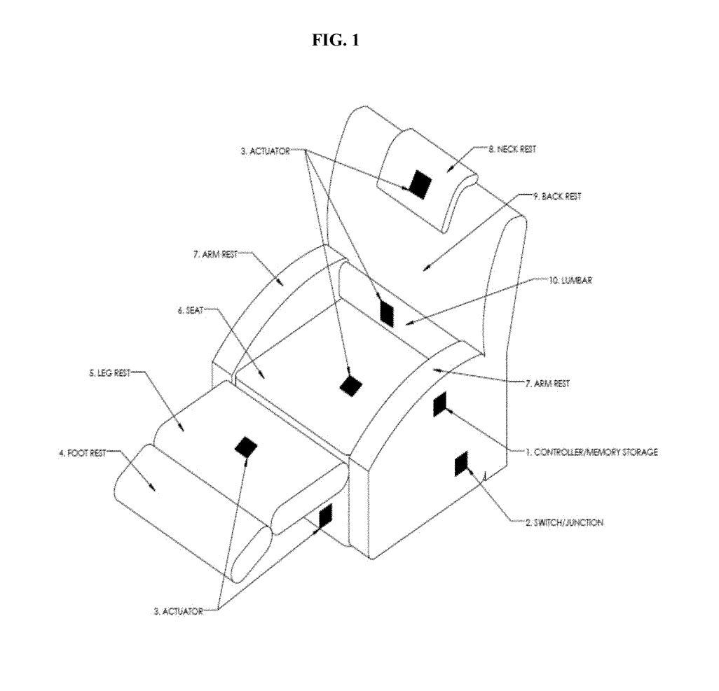

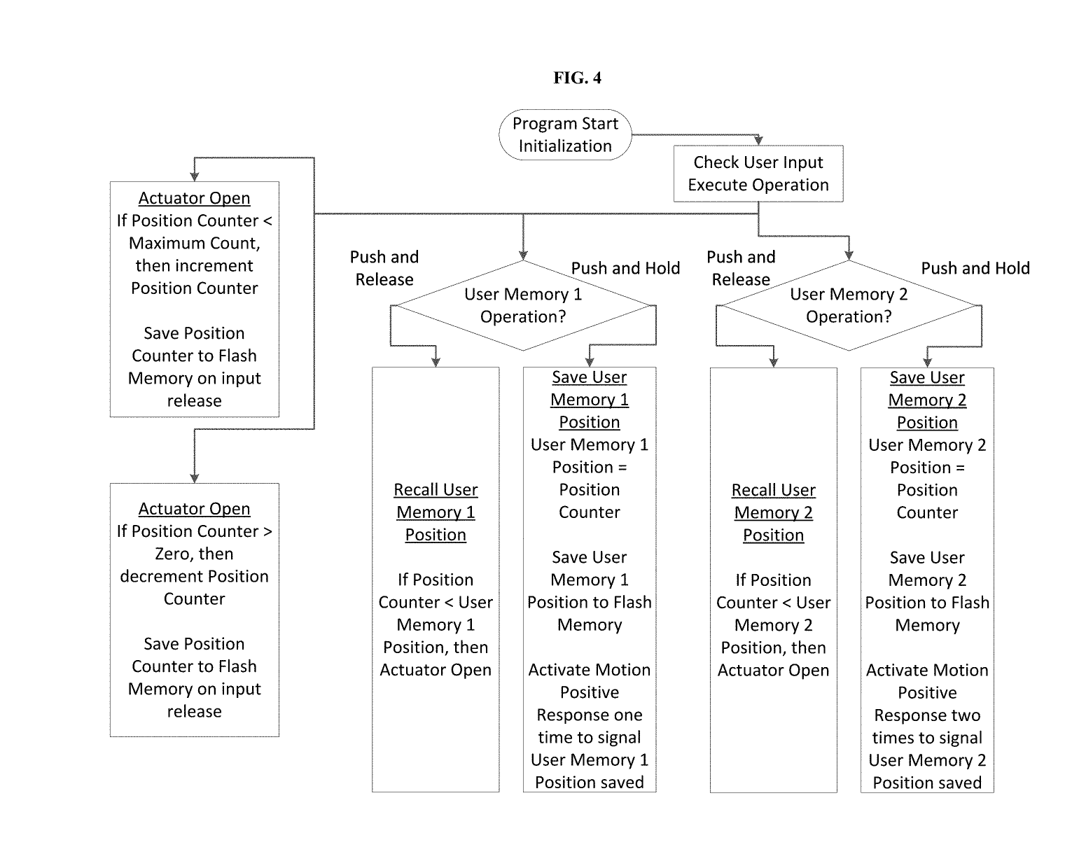

Non-limiting examples of a system for controlling the positioning of power motion furniture of the invention is depicted in the drawings and described below. For example, a system for controlling power motion furniture positioning embodied by the invention is shown in FIGS. 1-4. In some embodiments, and as shown, for example in FIG. 1, a system for controlling power motion furniture positioning of the invention comprises furniture components (e.g., control/memory storage means 1, switch/junction 2, one or more actuators/motors 3, foot rest 4, leg rest 5, seat 6, one or more arm rests 7, neck/head rest 8, back rest 9, lumbar 10), and a physical alert means for indicating that a specific positioning of the furniture components has been attained, has been selected, and/or set/saved in the memory storage means. The invention is not limited to any particular controller, memory storage means, actuator, means for setting and saving specific positioning of the furniture within the memory storage means, and/or a physical alert means. Indeed, any combination of the different types of controllers, memory storage means, actuators, means for setting and saving specific positioning of the furniture within the memory storage means, and/or physical alert means described herein may be used. In one embodiment, the system comprises a controller comprising software that executes logic depicted in FIG. 4 and that utilizes a counter (e.g., timer) to determine actuator position. In one embodiment, the controller is universally compatible with any actuator. In another embodiment, a software component of the controller is configured to assign a fully retracted (closed) actuator position a counter value of 0. In a further embodiment, a software component of the controller is configured such that the actuator counter value varies depending on the actuator length and motor speed. For example, in one embodiment, the actuator counter value is hardcoded in software to a calculated value for a specific actuator. In another embodiment, the actuator counter value is set using dipswitches to set the actuator counter value. For example, in one embodiment, when an actuator is activated, the counter will count up or down depending on the direction of the movement (e.g., a controller can be configured such that when the actuator is closed the counter will count down and when the actuator is open the counter will count up, or vice versa). In one embodiment, the position value is stored in the memory storage means (e.g., on-board flash, external flash device, or on the CPU volatile memory) when the actuator becomes deactivated. In some embodiments, when setting a user memory position, the user moves the actuator to a desired position and then saves the actuator position value to a designated user memory number. The set memory input can be a designated set memory button or a combination set/recall memory button (e.g., press and release to recall memory, press and hold to set memory).

In a further embodiment, upon setting and/or saving a user memory position, a software component of the controller deploys the physical alert means (e.g., moves (e.g., up and/or down, side to side, outward and/or inward, pulses, etc.) the actuator a number of times equal to the designated user memory number (e.g., user memory position 1 will move one time; user memory position 2 will move two times, etc.)). In some embodiments, upon setting and/or saving a user memory position, the controller software deploys a physical alert means comprising a brief activation (e.g., pulse) of a massage or other mechanism of the furniture for a number of times equal to the designated user memory number (e.g., user memory position 1 will activate/pulse once; user memory position 2 will activate/pulse twice, etc.). In another embodiment, when recalling a user memory position, a controller (e.g., a software component thereof) is configured to verify that the recall is valid. For example, in one embodiment, if the actuator position is equal to or greater than the user memory position number selected, the controller designates the request as invalid and does not change actuator position. In another embodiment, if the actuator position is less than the user memory position number selected, the controller designates the request as valid and the controller proceeds to move the furniture (e.g., via activation of the actuator) into a position equal to the user memory position. In a further embodiment, the controller is configured to prevent the actuator from retracting (e.g., closing) when the actuator position has exceeded the user memory position. For example, in one embodiment, when recalling a user memory position, a controller is configured (e.g., using software, firmware, detection components, etc.) to validate and/or detect that no obstructions are present in the path to be traveled by the actuator prior to initialing the request. The present invention is not limited by the type of obstruction detected and/or components used to detect an obstruction (e.g., detection system). Indeed a variety of detection systems and/or components may be utilized, including but not limited to, infrared detection systems and/or components, pressure sensing systems and/or components, acoustic monitoring systems and/or components, sound navigation and ranging (SONAR) systems and/or components, capacitive touch systems and/or components, resistive touch systems and/or components, digital mapping/picture correlation systems and/or components, current sensing systems and/or components, voltage sensing systems and/or components, force sensing systems and/or components, photo cell systems and/or components, etc.

Accordingly, the invention provides setting and/or storing an overall memory position for the piece of furniture (e.g., seating, bedding, etc.) using multiple actuators. The invention is not limited to an overall memory position setting/storing/recall. In a further embodiment, memory positions may be individually set and stored for each actuator and/or furniture component (e.g., back rest, head rest, leg rest, arm rest, lumbar, etc.) through use of the same methods and memory devices by either having individual memory storage buttons or a sequence for setting memory. In one embodiment, a sequence is programed in the control through software (e.g., that is known by the operator/owner). Once memory has been set for an individual actuator or furniture component, that actuator or component alone provides the physical alert. Thus, in one embodiment, the physical alert signifies the setting/storage for a single actuator and/or component rather than the setting/storage for the entire piece of furniture (e.g., comprising multiple actuators and/or components).

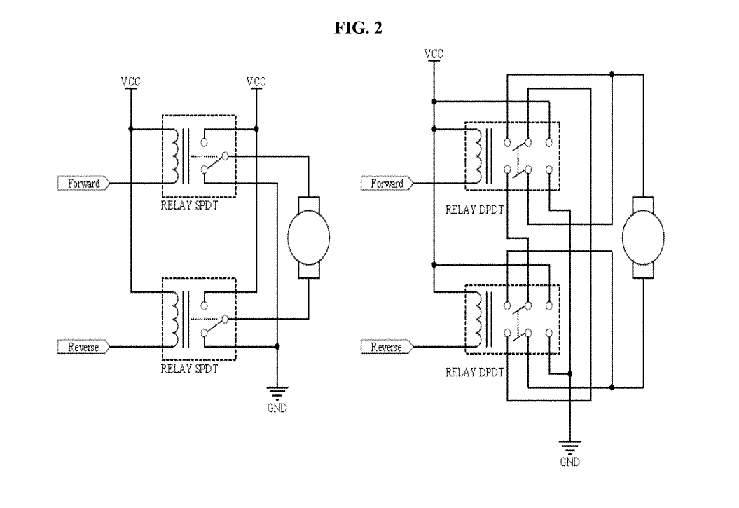

As shown in FIG. 2, in one embodiment, an actuator controls furniture positioning using two relays. For example, when utilizing the SPDT relay, the wires of the actuator are connected to the COMMON poles on each relay. The NORMALLY CLOSED poles are connected to ground and the NORMALLY OPEN poles are connected to Vcc (e.g., +29 VDC). Depending on the desired motor direction, the controller energizes the appropriate relay coil to switch the associated COMMON to Vcc.

When using the DPDT relays, the actuator wires are connected to the relay's COMMON and NORMALLY CLOSED poles in a way that both actuator wires connect together. Depending on the desired motor direction, the controller energizes the appropriate relay coil to switch the associated COMMONs to Vcc and ground.

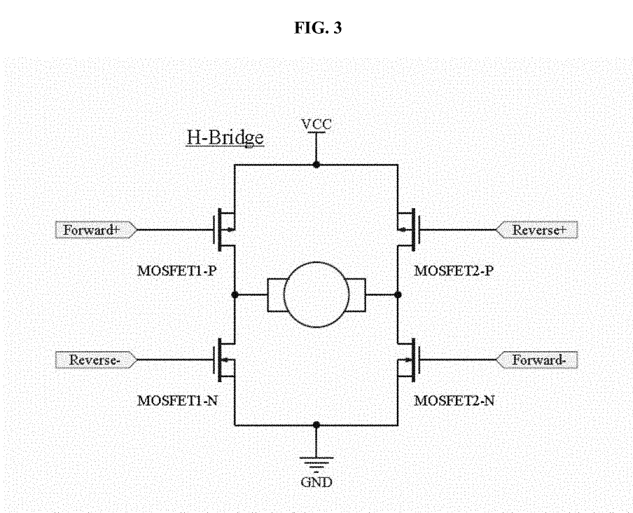

In one embodiment, an actuator utilizes four MOSFETs in an H-Bridge configuration as depicted in FIG. 3. For example, the H-Bridge uses two nMOSFETs and two pMOSFETs. Each actuator wires are connected to the DRAIN of an nMOSFET and a pMOSFET. The SOURCE of the nMOSFETs are connected to ground and the pMOSFETs are connected to VCC. Depending on the desired motor direction, the controller activates the GATE of a pMOSFET and the nMOSFET of the opposite side.

In one embodiment, a system for controlling power motion furniture positioning of the invention is configured to execute logic depicted in FIG. 4. For example, in one embodiment, upon power-up the CPU runs through a series of initialization processes as well as recalls the previous memory settings and the current actuator position. The controller monitors all buttons for user input. If the CPU determines that a button has been pressed, it continues to execute the desired operation. For example, under a scenario where an actuator open button or command is engaged, the controller moves the actuator in the OPEN direction. The actuator position counter begins to count up until the counter has reached the Maximum count or the button is released. When the button is released, the position counter is saved to flash memory. Under a scenario where an actuator close button or command is engaged, the controller moves the actuator in the CLOSE direction. The actuator position counter begins to count down until the counter has reached Zero or the button is released. When the button is released, the position counter is saved to flash memory. Under a scenario where a user memory button (e.g., user memory 1 button) or command is engaged via a push and release of the button the user memory position (e.g., user memory 1 position) is recalled. If the actuator position is equal to or greater than the user memory position (e.g., user memory 1 position), then the controller ignores the button push (e.g., and does not engage and/or activate the actuator). If the actuator position is less than the user memory position (e.g., user memory 1 position), then the controller moves the actuator in the OPEN direction and count up the actuator position until it is equal to the user memory position (e.g., user memory 1 position). The actuator position is then saved to flash memory. Under a scenario where a user memory button (e.g., user memory 1 button) or command is engaged via a push and hold of the button the user memory position (e.g., user memory 1 position) is set (e.g., the user memory 1 position is set equal to the actuator position counter (e.g., user Fmemory 1 position is saved in flash memory)). Upon saving the memory position (e.g., user memory 1 position), the system (e.g., CPU component of the system) activates the physical alert in order to signal that the user memory position has been saved (e.g., activates the physical alert one time to signal that user memory 1 position has been saved).

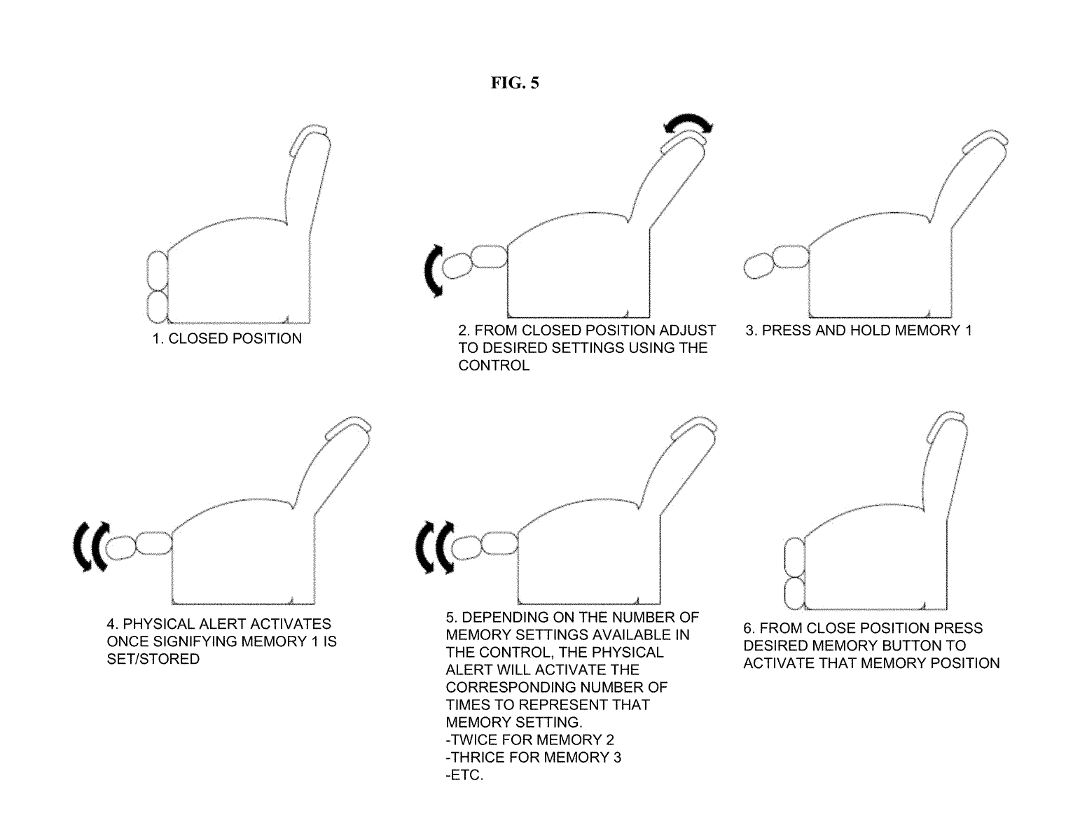

In another embodiment, and in like manner, under a scenario where a second or higher user memory button (e.g., user memory 2 button, third, fourth, fifth, sixth, seventh, eighth, ninth, tenth or more memory buttons) or command is engaged via a push and release of the button the user memory position (e.g., user memory 2 position) is recalled. If the actuator position is equal to or greater than the user memory position (e.g., user memory 2 position), then the controller ignores the button push (e.g., and does not engage and/or activate the actuator). If the actuator position is less than the user memory position (e.g., user memory 2 position), then the controller moves the actuator in the OPEN direction and count up the actuator position until it is equal to the user memory position (e.g., user memory 2 position). The actuator position is then saved to flash memory. Under a scenario where a user memory button (e.g., user memory 2 button) or command is engaged via a push and hold of the button the user memory position (e.g., user memory 2 position) is set (e.g., the user memory 2 position is set equal to the actuator position counter (e.g., user Fmemory 2 position is saved in flash memory)). Upon saving the memory position (e.g., user memory 2 position), the system (e.g., CPU component of the system) activates the physical alert in order to signal that the user memory position has been saved (e.g., activates the physical alert two times to signal that user memory 2 position has been saved). An exemplary, visual depiction of a memory storage and/or recall process in one embodiment of the invention is shown in FIG. 5.

In some embodiments, the present invention provides power motion furniture retrofitted to incorporate and utilize a positioning control system of the present invention. For example, as the memory logic (e.g., including hardware and software) is contained within the control itself and does not rely on assistance from the actuators, any existing actuator systems are compatible with the invention. The invention therefore provides, in some embodiments, connections (e.g., physical connections and/or connectors) between one or more actuator/motor systems of a piece of furniture and a control component of the systems and methods of the invention. The invention is not limited by the type of physical connections and/or connectors. The type of physical connection and/or connector may be selected based upon the type of actuator/motor of the furniture (e.g., any type of physical connection and/or connector known in the art can be adapted to control an actuator/motor). Exemplary physical connection and/or connector include, but are not limited to, any physical connection and/or connector that provides ground, power, and/or direction of current.

In some embodiments, the present invention provides a movement of a component of a piece of power motion furniture that satisfies certain requirements. For example, in some embodiments, power motion furniture containing a positioning control system of the present invention comprises any movement of a component of the power motion furniture that physically alerts a user of the furniture of the positioning of the components of the furniture. For example, in one embodiment, a movement of a component of the power motion furniture is detected by a user's head. In another embodiment, a movement of a component of the power motion furniture is detected by a user's back. In another embodiment, a movement of a component of the power motion furniture is detected by a user's leg or legs. In another embodiment, a movement of a component of the power motion furniture is detected by a user's shoulders. Indeed, any part of a user's body that can be physically alerted (e.g., moved, stimulated, massaged, etc.) using a component of power motion furniture with a positioning control system of the invention may be used. In one embodiment, a short extension and retraction of the actuator arm signals the user that memory has been set and stored. The length of the extension and retraction is programmable and therefore limited only by the length of the arm of a particular actuator. In this embodiment, the extension and retraction need only be that amount which a user physically feels and/or detects (e.g., a fraction of an inch). In further embodiments, the actuator/motor may pulse or vibrate as the physical alert. Again, as a programmable feature of the control, the duration, direction, and/or number of repetitions of the physical alert is limited only by the operation of the actuator/motor.

Power motion furniture comprising a positioning system of the present invention can be programmed to move (e.g., raise and/or lower) to a specific height. Power motion furniture comprising a positioning system of the present invention can be programmed to move (e.g., raise and/or lower) to a specific degree of recline (e.g., of a backrest and/or leg rest).

The ability of a user to program furniture position (e.g., using the signal from a control to move actuators and position component(s) of the piece of furniture (See, e.g., FIG. 1, components 1 and 3) and physically be alerted to the programmed position is a significant improvement in the field. For example, a physical alert to a programmed furniture position permits (e.g., at the push of a switch/button on a control, See, e.g., FIG.

1 control/memory storage 1 (e.g., located on an arm or other position of the furniture)) a user to set furniture position without a visual and/or audible cue or alert. This is in contrast to conventional powered motion furniture that rely on visual and/or audible cues to alert a user to furniture position settings. The physical alert is an active feedback that allows the user to feel the chair's motion/reaction and know the control has completed its task. This allows the control to be mounted in places on the furniture that may not be directly visible to the user. Also, without use of an audible cue, the control can indicate task completion in noisy environments (e.g., home living rooms or theaters). The ability of the control to signal memory storage through a physical alert is also favorable to those with particular sensory disabilities (visual or hearing impaired). Thus, power motion furniture comprising a positioning system containing a physical alert means of the present invention comprises components that provide functionalities heretofore not available in power motion furniture.

In some embodiments, a controller of the present invention is configured to store (e.g., in memory) a user set furniture positioning (e.g., set by pressing a height and/or recline set switch/button 40 shown in FIG. 1). In some embodiments, when a user resets the furniture positioning, the previously recorded furniture positioning is removed from memory and the new furniture positioning is recorded in its place.

The present invention is not limited to any particular controller. Indeed, a variety of controllers may be utilized to receive (e.g., from a relay, button and/or switch), process, and/or send information regarding furniture component positioning. For example, controllers that find use in the present invention include, but are not limited to, hand controls (push button, touch sensor), mounted controls (push button, touch sensor, LCD, motion sensing, voice activated), wireless controls (bluetooth, RF, IR, WiFi), tactile switches, toggle switches, rocker switches, slide switches,and/or rotary switches. In some embodiments, a controller utilized in the present invention integrates a 12-bit analog-to-digital converter (ADC), queued serial peripheral interfaces (QSPI), and/or a four channel general purpose timer (GPT) (e.g. capable of pulse width modulation (PWM)). The present invention is not limited to any particular controller. Indeed, any controller comprising one or more of the functions described above can be utilized herein. In a preferred embodiment, a furniture positioning control system of the present invention utilizes a mounted control with silicone keypad push buttons, utilizing a microcontroller/counter to track actuator positions and recall memory settings.

In some embodiments, a controller stores data in non-volatile flash memory, which communicates with the microcontroller via a serial peripheral interface (SPI) bus. During operation of the furniture, the microcontroller is configured to save and access a variety of data including furniture component positioning. The controller is also configured to log events into a memory component (e.g., flash memory) of the furniture.

Having described the invention in detail, those skilled in the art will appreciate that various modifications, alterations, and changes of the invention may be made without departing from the spirit and scope of the present invention. Therefore, it is not intended that the scope of the invention be limited to the specific embodiments illustrated and described.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields, are intended to be within the scope of the following claims.

What is claimed is:

1. A system for controlling positioning of power motion furniture comprising:
A) a controller comprising a switch and memory storage means;
B) an actuator;
C) a means for setting and saving a specific positioning of one or more components of the furniture within the memory storage means; and
D) a physical alert means that indicates a specific positioning of the one or more components of the furniture has been set and/or saved in the memory storage means.

2. The system of claim 1, wherein the one or more components of the furniture is selected from the group consisting of a seat, a backrest, a headrest, a leg rest, a lumbar component, a footrest, and an armrest.

3. The system of claim 1, wherein a software component of the controller assigns a counter value that correlates with actuator position.

4. The system of claim 1, wherein a software component of the controller deploys the physical alert means upon a user setting and/or saving a user memory position of one or more components of the furniture.

5. The system of claim 4, wherein the physical alert means comprises moving the actuator.

6. The system of claim 5, wherein the actuator is moved a number of times equal to a designated user memory number.

7. The system of claim 4, wherein the physical alert means comprises a pulse activation of a massage component of the furniture.

8. The system of claim 7, wherein the massage component is pulsed a number of times equal to a designated user memory number.

9. The system of claim 1, wherein the physical alert means comprises a movement and/or engagement of one or more components of the furniture.

10. The system of claim 9, wherein the one or more components of the furniture are selected from the group consisting of the head or headrest, backrest, lumbar, seat, leg rest, foot rest, neck or neck rest, arm or armrest, leg or legs, lift, and massage.

11. The system of claim 9, wherein the movement is selected from the group consisting of a back and forth movement, a side to side movement, a telescoping movement, an outward or inward movement, a sideways movement, a pulse, and a cycling movement.

12. The system of claim 9, wherein controller causes the movement to occur a number of times equal to a designated user memory number

13. The system of claim 9, wherein the movement is selected from the group consisting of a shake, a jog, a jitter, a nudge, a poke, a tickle, and a squeeze.

14. The system of claim 9, wherein the physical alert means is independent from a visible alert or signal and/or from an audible alert or signal.

15. A power motion furniture apparatus comprising a positioning control system comprising:
A) a piece of furniture comprising one or more components the movement of which are controlled by a powered actuator,
B) a controller comprising a switch and memory storage means;
C) a means for setting and saving a specific positioning of the one or more components of the power motion furniture within the memory storage means; and
D) a physical alert means that indicates a specific positioning of the one or more components of the power motion furniture has been set and/or saved in the memory storage means, wherein the physical alert means comprises a movement of one or more components of the furniture.

16. The power motion furniture apparatus of claim 15, wherein the piece of furniture is selected from the group consisting of a chair, a loveseat, a sofa, a sectional, a theater seat, a bed, a cot, and a vehicle seat.

17. The power motion furniture apparatus of claim 15, wherein the powered actuator is an electrically powered actuator.
